(19) United States
(12) Patent Application Publication
(10) Pub. No.: US 2008/0206412 A1
(43) Pub. Date: Aug. 28, 2008

(54) Supplementary Food Compositions

(75) Inventor: Christian Leclerc, Dun-sur- Auron (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Larena, Paris (FR)

(21) Appl. No.: 11/886,140

(22) PCT Filed: Mar. 15, 2006
(86) PCT No.: PCT/FR2006/000576

§ 371 Date: Nov. 9, 2007

(30) Foreign Application Priority Data
Mar. 15, 2005 (FR) 0502552

(51) Int. Cl. A23L 1/304; A23L 1/30

(52) U.S. Cl. 426/271; 426/649

(57) ABSTRACT

A supplementary food composition comprising at least one organic mineral salt that contributes to alkaline power in a quantity ranging from 20 to 200 mEq and is capable of neutralizing an acidic charge of 20 to 200 mEq of H⁺ hydrogen ions H⁺ or 20 to 200 mmol of H⁺.

### RELATED APPLICATION

This is a §371 of International Application No. PCT/FR2006/000576, with an international filing date of Mar. 15, 2006 (WO 2006/097629 A1, published Sep. 21, 2006), which is based on French Patent Application No. 05/02552, filed Mar. 15, 2005.

### TECHNICAL FIELD

This disclosure relates to a supplementary food composition to be administered orally as a food complement. This composition improves the prevention of ionic and mineral problems, e.g., during aging, hyperproteinated and restrictive, mineral-poor regimes, and in various pathologies such as metabolic acidosis, hypertension, cardiovascular diseases, type 2 diabetes, lithiases and osteoporosis.

### BACKGROUND

Current foods can be the origin of acido-basic and mineral imbalances as well as of ionic homeostasis problems that cause irregularities of physiological functions and can even bring about various pathologies such as hypertension, cardiovascular diseases, osteoporosis, lithiases and type 2 diabetes.

The current foods of Western populations are as a general rule acidifying, expressed by an increased mobilization of the buffer powers of the organism for maintaining the pH of the organism. This mobilization brings about ionic and mineral imbalances expressed by an increased acidic renal excretion and a urinary mineral and ionic loss. The Net Acid Excretion (NAE), measure currently used (NAE=titratable acidity+NH₄⁺−HCO₃⁻) in the studies on acido-basic metabolism does not reflect the acidic load of the meal, but rather the ability of an individual to manage the acidic load. The NAE correlates with the degree of metabolic acidosis. Urinary mineral losses, especially of calcium, are thus increased during an elevated NAE. These mineral losses probably reflect ionic imbalances at the cellular level.

During the course of pathologies such as hypertension (HTA) and type 2 diabetes, an elevation of the cytosolic free calcium is observed whereas the extra-cellular concentrations of ionized calcium are reduced. Such modifications are also in encountered in elderly persons. As a result of this fact elevated cytosolic basal contents of free calcium as well as an alteration of the transport of calcium at the membrane level are found in the platelets, the erythrocytes, the lymphocytes and the adipocytes of hypertensive subjects. The arterial pressure correlates directly with the intracellular ratios of calcium.

In type 2 diabetes, even in the absence of HTA, the intracellular ratios of calcium are also elevated. Deficiencies of the transportation of calcium are found at the level of all the tissues in type 2 diabetics, including the cardiac and skeletal muscles, the arteries, the kidneys, the liver, the erythrocytes, the osteoblasts and the adipocytes as well as the platelets.

The intracellular potassium is reduced in treated or non-treated hypertensive persons as well as in type 2 diabetics. On the other hand, in non-diabetic subjects an inverse correlation has been demonstrated between the intracellular potassium and the level of arterial pressure.

An inverse correlation is observed between the intracellular contents of potassium and calcium in normal and non-treated hypertensive persons. On the contrary, the intracellular magnesium develops concommitantly with the potassium. Likewise, a perfusion of sodium chloride (NaCl) increases the ratio of intracellular sodium and reduces that of potassium.

In sum, a depletion of potassium and/or of magnesium and/or an excess of intracellular calcium could produce or predispose a vasoconstriction, an HTA, but also contribute to the insulin resistance and to anomalies of the glucido-insulin metabolism.

The ATP-dependent sodium/potassium pump (NaK-ATPase) is the principal mechanism responsible for maintaining the low intracellular concentration of sodium and the high intracellular concentration of potassium. The NaK-ATPase pump is responsible for maintaining the membrane potential. The activity and the capacity of the NaK-ATPase is under the control of hormones, contractile activity, physical exercise, nutrition and electrolytic status.

In animal models, a deficiency of potassium results in a reduction of the concentration of NaK-ATPase in the skeletal muscle. In humans, a deficiency of potassium induced by diuretic treatments induces the same effects. A reduction of 53% of the concentration of NaK-ATPase at the muscular level brings about a reduction of 88% of the ratio of the force.

The physiological role of the sodium-calcium exchanger (Na/Ca) has still not yet been clearly defined. In experiments on a re-perfused ischemic heart, the increase of intracellular sodium slows the extrusion of calcium via the exchanger. This exchanger consequently plays an important part in ventricular arrhythmias by modifying the membrane potential.

Another path for the influx of sodium into the cardiac cells is the sodium/proton exchanger (Na⁺/H⁺) (NHE) that plays an important part in the regulation of the intracellular pH and the cellular volume. The NHE excretes a proton for an entering sodium ion. The activity of the NHE is very sensitive to the intracellular pH. The extrusion of protons via the NHE is also inhibited by extracellular acidosis. The intracellular sodium can also regulate the NHE, but it is not the principal regulator.

The sodium/bicarbonate exchanger (Na⁺/HCO3⁻) plays a part in the extrusion of acid at the level of the myocytes (via the influx of Na⁺ and HCO3⁻). The activity of the NBC is dependent on the pH. In these physiological conditions, the NBC and NHE play a similar part in the influx of sodium.

The sodium/potassium/2 chlorides (Na⁺/K⁺/2Cl⁻) (NKCC) co-transport plays an important part in maintaining intracellular chlorine (Cl⁻). Strong concentrations of Cl⁻ inhibit ionic fluxes in both directions. Furthermore, this transporter can be important in regulating cellular volume.

The exchanger Na⁺/Mg²⁺ is responsible in part for the extrusion of magnesium out of the cell. Although this antiport is not the principal regulator of intracellular concentrations of magnesium, it permits an outflow of magnesium in proportion to the extracellular content of sodium.

A charge of NaCl is accompanied by an increase of the cellular concentrations of sodium and calcium, but a diminution of the concentrations of magnesium. Inversely, a charge of magnesium diminishes the intracellular sodium and increases the ratio of intracellular magnesium. Diminution of intracellular sodium is accompanied by a lowering of arterial pressure. A complementation of potassium and of magnesium prevents induction of the inhibition of NaK-ATPase. The effects of potassium and magnesium appear to be additive.

A deficit of potassium, including at the same time, hypokaliemia and diminution of the intracellular potassium can represent a consequence of the magnesium deficit. This magneso-curable and non-kaliocurable depletion is connected to membrane modifications and in particular to an inhibition of the NaK-ATPase magnesium-dependent activity, indispensable for the transport of potassium and sodium to the inside and outside of the cell. Magnesium also blocks the potassium currents exiting at the level of the potassic canals. On the other hand, magnesium is indispensable for the reabsorption of potassium in the loop of Henle and the magnesium deficit stimulates secretion of renin and aldosterone, from which kaliuria can occur. The potassium deficit contributes to the cardiovascular consequences of the magnesium deficit.

The mechanisms intervening in regulating the intracellular ratios of the different ions have not yet been clearly defined. Sodium plays an important part in the activation of NaK-ATPase. In fact, food sodium provided in the form of sodium chloride brings about the induction of an inhibitor of the NaK-ATPase activity, which contributes to the accumulation of sodium in the cell. On the other hand, if sodium is provided in a different form from chloride, it does not induce synthesis of the NaK-ATPase inhibitor. Finally, NaCl facilitates the activity of the Na⁺/H⁺ exchanger. Inversely, potassium diminishes the activity of this sodium-proton exchanger. Moreover, potassium and magnesium prevent the synthesis of the NaK-ATPase inhibitor. Consequently, it would seem that sodium chloride facilitates the retention of sodium by the cell whereas food potassium and magnesium seem to facilitate the extrusion of sodium from the cell.

The cellular mechanisms described above and implicated in the ionic transports can be observed in different organs such as, e.g., the heart and the kidney. As concerns sodium, it appears to be confirmed that it is the association of sodium with chlorine that has deleterious effects. The increase of the vascular volume observed during a charge of sodium chloride can be explained by the induction of an inhibitor of the NaK-ATPase pump. The effect of NaCl on the vascular volumetric expansion would be connected to the part of the Na/K/2Cl co-transport in the retention of sodium at the renal level. This mechanism would be inoperative at low concentrations of chlorine in the tubular fluid.

As for calcium, it plays an important part at the cellular level. It intervenes in particular in the processes of muscular contraction, described in the problems of HTA. In the SIR rat, a spontaneously hypertensive rat, a regime rich in calcium increases urinary excretion of sodium, the activity of the membrane Ca-Atlases of erythrocytes, reduces the intracellular concentration of calcium of the platelets, and improves the relaxation of the smooth vascular muscular cells. This effect of calcium appears to be connected to an improvement of membrane hyperpolarization by opening potassium canals activated by calcium.

Several observational studies have demonstrated clearly that in populations living with food low in NaCl, the level of arterial pressure increases only a little or even not at all with age. The most complete study (Intersalt) has shown that the more significant the supply of sodium is, the greater the number of individuals in which the systolic and diastolic pressures increase with age.

The hypothesis according to which the deficit of magnesium favors atherosclerosis is currently envisaged. In several experimental models, the deficit of magnesium favors dyslipidemias, increases the peroxydability of lipoproteins and induces an inflammatory response.

Various studies have demonstrated a positive correlation between the urinary excretion of calcium and metabolic acidosis. Thus, a buffer reaction is noted that puts in play the mineral reserves of the bone, the calcium salts bicarbonates and potassium. The phenomena can therefore cause a loss of bone, all the more since metabolic acidosis has an incidence at the level of the osseous cells themselves by inhibiting the osteoblastic function and stimulating resorption.

The excess of sodium also brings about a hypercalciuria. An insufficient excretion of sodium causes an increase of the volume of the blood, which causes an increase of urinary calcium.

The insufficiency of potassium supplies increases the retention of sodium at the renal level, which increases hypercalciuria. Moreover, hypokaliemia stimulates the osseous resorption whereas the concentration of potassium reduces the renal elimination of calcium and rebalances the calcemia. A deficit of magnesium causes a hypocalcemia and inhibits the active synthesis of vitamin D: this deficit is considered to be a significant risk factor for osteoporosis. Moreover, the serumal ratio of magnesium is directly connected to the in vitro proliferation of osteoblastic cells.

The incidence of lithiases has not ceased to increase during the course of recent decades. This is connected to changes of food habits: consumption of animal proteins, NaCl, alcohol, insufficient supply of drink are some of the food factors aggravating the risk of urinary lithiases. The excessive supply of animal proteins brings about a lowering of urinary pH, whereas excretions of calcium, oxalate and uric acid are increased. Furthermore, lithiases are associated with significant mineral losses. In fact, an elevated urinary excretion of sodium is generally observed in persons presenting calculi.

Low consumptions of magnesium, calcium and potassium as well as an excessive concentration of NaCl can be risk factors for insulin resistance and diabetes.

The epidemiological data shows a great prevalence (25%) of hypomagnesemia among diabetic subjects. The depletion could be in part explained by a diminution of the net tubular reabsorption of magnesium in the different hyperinsulinemic states (diabetes, obesity, HTA . . . ). Moreover, a chronic deficiency of magnesium could contribute to insulin resistance. A free intracellular depletion of magnesium was also found to be a characteristic of insulin resistance among hypertensive subjects.

A depletion of potassium results in modifications of the expression of NaK-ATPase in the skeletal muscle, the heart and the nerves, which could also play a significant part in the physiopathology of diabetes. Moreover, the ionic hypothesis could explain the concomitant appearance of several pathologies in the course of the polymetabolic syndrome. This is corroborated by the fact that insulin resistance and hyperinsulinemia are both associated with mineral imbalances.

The effect of a potassium deficiency in the genesis of type 2 diabetes might also be connected to a perturbation of the homeostasis of magnesium. Thus, low plasmatic concentrations of potassium might disturb the renal re-absorption of magnesium and consequently result in hypomagnesemia.

A regime low in calcium results in increased levels of parathormone (PTH) that can compromise the sensitivity to insulin of adipose cells and probably of numerous other cell types by inducing increased levels of intracellular calcium.

The efficacy of the absorption of calcium diminishes with age, frequently associated with an insufficiency of food supplies, with a lack of vitamin D as well as with a compensatory hyperparathyroidism.

Aging is generally accompanied with renal modifications among which a diminution of the glomerular filtration. The rate of glomerular filtration decreases by approximately 1.05 ml/min per year in elderly persons.

A progressive increase in the acidity of the blood and a diminution of the bicarbonate content is noted during aging. The modifications of the blood reflect a metabolic acidosis that increases during aging. Furthermore, age and diet are two independent factors in the regulation of the degree of acidosis with age amplifying the acidic charge induced by diet.

Therefore, age and glomerular filtration are two non-dissociable factors responsible for controlling acidity of the blood and plasmatic bicarbonates.

Metabolic acidosis favors muscular proteic catabolism. Furthermore, osteoporosis is characterized not only by a loss of the osseous stock of calcium, but also by an alteration of the proteic structure of the bone. It can be readily seen that this type of synergy that can be established in the case of prolonged metabolic acidosis can have very deleterious effects.

Sarcopenia is to be sure a multifaceted phenomenon: slow erosion of muscular proteins, faulty regulation of cytokines, degeneration of motoneurons, physical inactivity, produced hormone levels. However, another hypothesis has likewise been advanced relative to the effects of metabolic acidosis. In fact, the decline of the renal function associated with a diet with acidifying nature in elderly persons might contribute to accentuating the proteic catabolism in these persons.

The ability of fructo-oligosaccharides (FOS) to stimulate the proliferation of bifido-bacteria contributes to the maintenance of intestinal flora. With this bifidogenous effect, FOS prevent the appearance of diarrhea that can be at the origin of digestive mineral (Ca, Mg, K . . . ) and ionic (bicarbonates . . . ) losses.

In addition to their effect on the intestinal flora and, contrary to the effect of certain food fibers, FOS's facilitate the intestinal absorption of certain minerals. Thus, stimulation of the absorption of minerals such as Ca²⁺ and Mg²⁺ by inulins has been confirmed numerous times in the rat. It would appear that the use of different models (rats and hamsters) indicates an increase of the absorption in the large intestine resulting in an increase of the osseous density.

Renal calculi are the result of a complex between calcium and oxalate. An acidic charge is generally accompanied by an excess of oxalic acid contributing to the formation of these calcic crystals. Citrate plays an important part in the metabolism of calcium and especially in the inhibition of the formation of these calcic crystals. Thus, urinary citrate is an endogenous inhibitor of the formation of crystals by complexing with calcium. Low urinary concentrations of citrate are associated with the development of renal calculi. Furthermore, alkalinizing beverages prevent the formation of calcium oxalate, uric acid and lithiase. Thus, the powders of fruits rich in citric acid elevate the urinary pH and the urinary excretion of citrate, bring about a diminution of the risk of crystallization between calcium and oxalic acid.

Moreover, citrate salts reduce the degree of metabolic acidosis, thus limiting the urinary mineral and ionic losses while improving the status of bicarbonates in the organism. They therefore contribute to reducing NAE.

Potassium plays an important part in maintaining the ionic homeostasis at the cellular level. In fact, potassium prevents the induction of the NaK-ATPase inhibitor and consequently contributes to maintaining the membrane potential. Furthermore, it reduces the risk of cerebral vascular accidents. Finally, potassium intervenes at the urinary level and facilitates excretion of citrate, thus preventing the formation of calcic crystals and therefore of lithiases.

Calcium also prevents the development of lithiasis by preventing absorption of oxalates at the intestinal level. Calcium also reduces the risk of developing diabetes.

In addition, calcium is essential in the osseous construction. It is incorporated in the mineral fraction of bone. An adequate supply of calcium appears to be of prime importance for maintaining the osseous skeleton, in particular, during metabolic acidosis induced by food.

Calcium also intervenes in the processes of muscular contraction, described in the problems of HTA.

As for magnesium, it plays a part similar to that of potassium. Their effects are additive at the cellular level, especially by their effect on NaK-ATPase. In fact, magnesium also prevents induction of the inhibitor of this pump. In addition, at the cellular level, magnesium blocks the exiting potassium currents and facilitates extrusion of sodium out of the cell.

Moreover, magnesium intervenes as a cofactor of numerous enzymes. Its involvement in the functioning of NaK-ATPase makes it an important mineral in maintaining mineral equilibriums at the cellular level.

Finally, magnesium has a certain number of effects on the metabolism of citrates and reduces the urinary saturation of calcium oxalates by forming magnesium oxalate, which is more soluble than calcium oxalate.

In the digestive tract magnesium can also form complexes with the oxalates, thus reducing the intestinal absorption of oxalates.

The importance of the food supply in maintaining the ionic and mineral equilibrium will be understood since the majority of the elements participating in this maintenance are supplied by food.

In the prior art, different compositions have been developed to attempt to remedy these problems of ionic imbalance. However, no composition described in the prior art yields results satisfactory for alleviating these problems of ionic imbalance and/or it proves to be difficult to administer to patients. In the case of liquid compositions developed in the prior art, if they permit a simplified administration they turn out to be complex to manufacture due to the fact of the mediocre solubility of some of their components.

It could therefore be advantageous to provide a nutritional composition that allows the situation to be managed in a micronutritional manner to prevent the appearance of problems associated with mineral and ionic imbalances as well as with elevated mineral and ionic urinary excretions such as metabolic acidosis, hypertension, cerebral vascular accidents, type 2 diabetes, osteoporosis and urinary lithiases.

### SUMMARY

I provide a supplementary food composition including at least one organic mineral salt that contributes to alkaline power in a quantity ranging from 20 to 200 mEq and is capable of neutralizing an acidic charge of 20 to 200 mEq of H⁺ hydrogen ions or 20 to 200 mmol of H⁺.

I also provide a method of reducing ionic and mineral imbalances including administering a therapeutically effective amount of the composition to a mammal.

### DETAILED DESCRIPTION

I provide a composition, preferably a supplementary food composition, comprising at least one organic mineral salt, which organic mineral salt contributes to the alkaline power in a quantity ranging from 20 to 200 mEq of H⁺ hydrogen ions, that is, 20 to 200 mmol mf H⁺, preferably from 40 to 100 mEq.

I surprisingly determined that the compound in the composition presents complimentary modes of action, thus offering a synergy for a more efficacious action, and the mixture of these latter in determined quantities permits the obtention of a composition in the form of a powder that dissolves without difficulty.

The organic mineral salt can be selected from potassium salts, magnesium salts or calcium salts.

The organic mineral salt can be selected from citrate salts, malate salts, lactate salts or gluconate salts, preferably citrate salts. The composition can comprise one of the salts or any combination of them.

The organic mineral salt can preferably be selected from potassium citrates, magnesium or calcium, quite preferably potassium citrate and, in a particularly preferred manner, the organic mineral salt is a mixture of potassium citrates, magnesium and calcium.

When a potassium salt is used the potassium can be present in the composition in a quantity ranging from 2 mmoles to 75 mmoles, preferably from 10 mmoles to 50 mmoles. According to a particular form, the potassium can be present in the composition in the form of tri-potassium citrate.

When a calcium salt is used, the calcium can be present in the composition in a quantity ranging from 1 mmole to 30 mmoles, preferably from 5 mmoles to 20 mmoles. According to a particular form, the calcium can be present in the composition in the form of tri-calcium citrate.

When a magnesium salt is used, the magnesium can be present in the composition in a quantity ranging from 1 mmole to 20 mmoles, preferably from 4 mmoles to 12 mmoles. According to a particular form, the magnesium can be present in the composition in the form of tri-magnesium citrate.

The compositions can be present in the form of powder to be diluted, drinkable solution, powder for capsules, tablets or also granules.

The composition may be in the form of powder to be diluted. The composition may be in the form of a drinkable solution.

This solution advantageously has a volume of 100 ml to 2 l when it is intended for daily administration, preferably of 200 to 1000 ml and in a particularly preferred manner of 300 to 800 ml, especially 500 ml.

The composition may furthermore comprise a prebiotic. By way of example, this prebiotic can be selected from fructo-oligosaccharides of the inulin or oligo-fructose type, galacto-oligosaccharides of the transgalacto-oligosaccharide or galactotriose type, the isomalto-oligosaccharides or also the manno-oligosaccharides. The prebiotic can preferably be selected from the fructo-oligosaccharides. Even more preferably, the prebiotic can preferably be selected from the fructo-oligosaccharides of the oligofructose type. The oligofructoses can stem from chicory, onion, garlic, artichoke, leeks, salsify, asparagus and preferably from chicory. The prebiotic can be present in the composition in a quantity ranging from 2 g to 15 g, preferably from 2 g to 6 g.

The composition may also comprise fruit powder. The fruit powder can be rich in organic salts such as citrate salts and/or malate salts. The salts can be of mineral citrate and/or mineral malate and the minerals can be potassium, calcium, magnesium, zinc, manganese, preferably potassium, calcium, magnesium and very preferentially potassium.

By way of example, the fruit powder can be selected from lemon powder, orange powder, passion fruit powder, grapefruit powder, the powder of red fruits such as currants, huckleberries or raspberries or also from prune powder. The fruit powder is preferably lemon powder.

The fruit powder can contribute to the alkaline power in a quantity ranging from 5 mEq to 30 mEq, capable of neutralizing an acid charge of 5 to 30 mEq of hydrogen ions H⁺, or 5 to 30 mmoles of H⁺.

The composition of the invention can furthermore comprise vitamin D and/or glutamine. The vitamin D can be present in the composition in the form of cholecalciferol (vitamin D3) or also ergocalciferol (vitamin D2). The vitamin D is preferably present in the composition in the form of cholecalciferol (vitamin D3). The vitamin D can be present in the composition in a quantity ranging from 1 μg to 20 μg, preferably from 2.5 μg to 15 μg.

Glutamine can be present in the composition in the form of free L-glutamine or of proteins or of proteic extracts rich in glutamine. Glutamine is preferably present in the composition in the form of free L-glutamine.

Glutamine can be present in the composition in a quantity ranging from 100 mg to 10 g, preferably from 100 mg to 3 g. Those skilled in the art know how to adapt the quantity of protein or of proteic extract containing glutamine to obtain the desired quantity of glutamine in the composition.

Furthermore, the composition can contain any other active ingredient known for treating problems connected with ionic and mineral imbalances, in particular, those known in diuretic treatments, antihypertensive treatments, treatments of type 2 diabetes, osteoporosis treatments and lithiase treatments.

The compositions can also comprise, according to the formulation selected, any appropriate excipient such an acidifier, an anti-agglomerant, a colorant, a flavoring, a sweetener.

A preferred composition comprises:
25.6 mmoles potassium in the form of 2.78 g of tri-potassium citrate;
10 mmoles calcium in the form of 1.9 g tri-calcium citrate;
6.25 mmoles magnesium in the form of 1.43 g tri-magnesium citrate.

This composition can advantageously also comprise:
5 g fructo-oligosaccharide in the form of 5 g chicory hydrolysate;
1 to 1 mEq alkaline in the form of 0.3 to 3 g lemon powder.

These quantities correspond to a daily dose to be diluted in 500 mL or more of water.

The different quantities previously described correspond to the quantities necessary for a daily administration. In the case in which administration of the composition follows a different posology, it is possible to adjust these quantities without difficulty to adjust them to the new posology. By way of example, a composition intended for a twice-a-day administration will comprise the different components previously described in a quantity corresponding to one half the quantities previously described.

Another advantage is the use of the supplementary composition for preparing a composition for preventing the appearance of problems associated with ionic and mineral imbalances.

In particular, I use the composition for preparing a composition for preventing and/or compensating mineral and ionic losses via the urinary and/or digestive path, for preventing and/or improving the ionic and mineral imbalances observed in metabolic acidosis, hypertension, cerebral vascular accidents, type 2 diabetes, lithiases, osteoporosis, aging and acidifying regimes such as hyperproteinated and restrictive regimes, poor in minerals.

This composition advantageously can be used to prepare a composition for preventing and/or compensating mineral and ionic losses via the urinary path.

Moreover, I use the composition for preparing a composition rich in minerals for alleviating deficits of micronutrients.

Other characteristics will appear in the following examples without them constituting any limitation.

### EXAMPLES

1) Preparation of a liquid composition:

The following different ingredients were added to a volume of water of 300 mL:
FOS (fructo-oligosaccharides) of chicory: 5 g
tri-potassium citrate: 2.78 g (or 100 mg or 25.6 mmol potassium)
tri-calcium citrate: 1.9 g (or 400 mg or 10 mmol calcium)
magnesium citrate: 1.43 g (or 150 mg or 6.25 mmol magnesium)
fruit powder (lemon juice): 0.5 g
flavorings
sweetener
thickener.

The different ingredients used correspond to an alkaline supply of approximately 65 mEq.

The dissolution of the mixture is total after agitation.

2) Test of urinary dosage:

A group of 60 persons consumed 150 mL of the liquid composition described at 1) in one day. A dosage of the net urinary acidic excretion (NAE) was performed before and after this consumption according to the protocol written in the ENA test kit designed by ABP.

The dosage was performed on the urines collected during the course of a period of 24 hours.

The NAE value obtained correlates with the degree of metabolic acidosis.

The data collected was divided into percentiles (the 50th percentile corresponds to the median value of urinary excretion for the group of 50 persons). The results obtained are resumed in table I.

TABLE I

| | Percentiles | | | | | | |
|---|---|---|---|---|---|---|---|
| | 5 | 10 | 15 | 50 | 85 | 90 | 95 |
| NAE before consumption | 40 | 45 | 50 | 70 | 100 | 110 | 120 |
| Composition (in mEq) | | | | | | | |
| NAE after consumption | 10 | 15 | 20 | 40 | 70 | 90 | 100 |
| Composition (in mEq) | | | | | | | |

The results show that the consumption of a demi-dose of the composition described at 1) in one day allows the net urinary acidic excretion to be lowered, a reflection of the acido-basic equilibrium of the organism. This effect is observed whatever the seriousness of the metabolic acidosis.

In conclusion, the composition permits the degree of metabolic acidosis and, thus, the urinary excretion of minerals to be reduced.

1-14. (canceled)

15. A supplementary food composition comprising at least one organic mineral salt that contributes to alkaline power in a quantity ranging from 20 to 200 mEq and is capable of neutralizing an acidic charge of 20 to 200 mEq of H⁺ hydrogen ions or 20 to 200 mmol of H⁺.

16. The composition according to claim 15, wherein the organic mineral salt is at least one selected from the group consisting of potassium salts, magnesium salts and calcium salts.

17. The composition according to claim 15, wherein the organic mineral salt is at least one selected from the group consisting of citrate salts, malate salts, lactate salts and gluconate salts.

18. The composition according to claim 15, comprising potassium in a quantity ranging from 2 mmol to 75 mmol.

19. The composition according to claim 15, wherein the composition comprises calcium in a quantity ranging from 1 mmol to 30 mmol.

20. The composition according to claim 15, wherein the composition comprises magnesium in a quantity ranging from 1 mmol to 20 mmol.

21. The composition according to claim 15, in the form of: a powder to be diluted, a drinkable solution, a powder for a capsule or tablets or granules.

22. The composition according to claim 15, which further comprises a prebiotic.

23. The composition according to claim 22, wherein the prebiotic is present in a quantity ranging from 2 g to 15 g.

24. The composition according to claim 15, further comprising fruit powder.

25. The composition according to claim 24, wherein the fruit powder contributes to the alkaline power in a quantity ranging from 5 mEq to 30 mEq, capable of neutralizing an acid charge of 5 to 30 mEq of hydrogen ions H⁺, or 5 to 30 mmoles of H⁺.

26. The composition according to claim 15, further comprising an acidifier, an anti-agglomerant, a colorant, a flavoring and/or a sweetener.

27. A method of reducing ionic and mineral imbalances comprising administering a therapeutically effective amount of a composition according to claim 15 to a mammal.

28. The method according to claim 27, wherein the composition 1) prevents and/or compensates for mineral and ionic losses via the urinary and/or digestive path or 2) prevents and/or improves ionic and mineral imbalances observed in metabolic acidosis, hypertension, cerebral vascular accidents, type 2 diabetes, lithiases, osteoporosis, aging and acidifying regimes comprising hyperproteinated and restrictive regimes that are poor in minerals.
